(19) United States
(12) Patent Application Publication
(10) Pub. No.: US 2008/0277458 A1
(43) Pub. Date: Nov. 13, 2008

(54) METHOD FOR THE SUBSEQUENT TREATMENT OF WELDED CONNECTIONS

(75) Inventors: Mustafa Kocak, Geesthacht (DE); Stefan Riekehr, Geesthacht (DE); Waman Vishwanath Vaidya, Geesthacht (DE); Frank Gartner, Hamburg (DE); Thorsten Stoltenhoff, Ennepetal (DE); Heinrich Kreye, Hamburg (DE); Thomas Klassen, Wentorf (DE)

Correspondence Address: HOVEY WILLIAMS LLP, 10801 Mastin Blvd., Suite 1000, Overland Park, KS, 66210, US

(73) Assignee: GKSS-FORSCHUNGSZENTRUM GEESTCHACHT GMBH, Geesthacht (DE)

(21) Appl. No.: 12/118,623

(22) Filed: May 9, 2008

(30) Foreign Application Priority Data
May 9, 2007 (DE) 102007021736.8

(51) Int. Cl. B23K 31/02

(52) U.S. Cl. 228/222

(57) ABSTRACT

A method for the subsequent treatment of welded connections is shown and described. The object of providing a method for the subsequent treatment of a weld by which the tensile stresses in the region of the weld are reduced is achieved by applying a top layer to the weld on a workpiece by cold-gas spraying.

### CROSS-REFERENCE TO RELATED APPLICATION

The present application claims the benefit of and priority from German Application No. DE 10 2007 021 736.8, filed May 9, 2007, the entire disclosure of which is hereby incorporated by reference herein.

### BACKGROUND OF THE INVENTION

1. Field of the Invention

The present invention relates to a method for the subsequent treatment of a weld on a workpiece, in order to improve the mechanical properties of the weld.

2. Discussion of the Prior Art

In particular in the area of aircraft construction, where aluminum is used to a very great extent, it is endeavored to connect workpieces that consist of this material or its alloys to one another by means of welds instead of by riveting, since this has an accompanying weight saving, which is highly relevant specifically in this area.

As in the case of all metals, it is also the case with aluminum that, no matter which thermal welding method is chosen, when producing a weld there is the problem that tensile stresses occur in the material of the weld itself and in the material of the adjacent workpieces in the region of the weld. These tensile stresses may on the one hand lead to the strength of the material being reduced. On the other hand, the tensile stresses may also have the effect under loading that cracks form in the region of the surface, further impairing the strength of the weld and accelerating the corrosion in this region.

To overcome the problem of tensile stresses, it is possible to anneal the welded workpieces, that is to say carry out a thermal treatment. If, however, the workpieces exceed a certain size, such treatment can no longer be carried out. Furthermore, with annealing there is the problem that the workpieces may possibly be distorted in the process, which is likewise undesired. Finally, subsequent thermal treatment is ruled out in the case of materials that are already hardened.

Furthermore, it proves to be a problem that the aluminum workpieces that are to be welded often consist of an aluminum alloy with a coating of pure aluminum, the coating serving as a “sacrificial anode”, in order to protect the aluminum alloy of the workpiece from corrosion. In the region of the weld, this coating is destroyed by the welding process, so that in this region the effect of the sacrificial anode is also lost and the aluminum alloy of the workpieces is more exposed here to corrosion attacks. Furthermore, the region of the weld becomes more electronegative as a result of mixing in of the material of the coating, and consequently is at increased risk of corrosion. It would therefore be desirable furthermore if, after the production of a weld on such workpieces, a sacrificial anode material were also present once again in the region of the weld.

### SUMMARY

It is therefore the object of the present invention to provide a method for the subsequent treatment of a weld by which the tensile stresses in the region of the weld are reduced.

This object is achieved according to the invention by a top layer being applied to the weld on a workpiece by cold-gas spraying.

In this case, the weld may be formed before the application of the top layer by any desired welding methods known from the prior art, gas fusion welding, arc welding and laser welding coming into consideration in particular. The weld may on the one hand serve the purpose of connecting two components to form a single workpiece, or on the other hand serve the purpose of closing openings in a workpiece.

In the cold-gas spraying, powdered material from which the top layer is formed is introduced into a gas jet inside a nozzle, so that the particles are accelerated to high speeds, typically to speeds above the speed of sound, and consequently high kinetic energies are imparted to them. When the particles impinge on the workpiece or the surface of the weld that is to be coated, they form a dense, firmly adhering layer, since the high kinetic energy and the resultant release of heat on impingement on the workpiece cause the particles to bond together and also to the workpiece. For details of cold-gas spraying, you are otherwise referred to German Patent No. DE 101 26 100 A1, and corresponding U.S. Pat. No. 7,143,967, both of which are hereby incorporated by reference herein in their entirety, to the extent not inconsistent with the present disclosure.

Due to the constant impact of further solid particles, cold-gas-sprayed layers have compressive stress after application to a workpiece. Furthermore, compressive stresses are introduced into the workpiece itself during the coating process.

This gives rise to the possibility of using the application of a cold-gas-sprayed layer to the surface of a previously formed weld to compensate for the tensile stresses in it, and consequently increase the strength. In this way, the tendency for cracks to form is also greatly reduced, so that in this way the corrosion resistance of the weld is improved.

If the size of the particles used in the cold-gas spraying lies between 10 and 60 μm, and preferably between 20 and 45 μm, it has been found that good results can be achieved with regard to the reduction of tensile stresses in the weld and the workpiece.

Even if the present invention is not restricted to workpieces made of a material comprising aluminum or aluminum alloys, the method according to the invention has proven to be particularly advantageous with regard to such workpieces. However, it is also possible for the method according to the invention to be applied to workpieces made of titanium or titanium alloys. In addition, the method according to the invention can be applied to workpieces made of steel; in particular whenever galvanized steel workpieces are subjected to subsequent treatment, it is possible to restore the originally good corrosion properties in the region of the weld. Furthermore, the method may also be applied to copper and copper alloys.

To further improve the corrosion resistance of the weld, it has proven to be advantageous if the material of the top layer behaves anodically with respect to the material of the weld. In this case, the top layer not only counteracts the tensile stresses, but at the same time serves as a sacrificial anode with respect to the weld, so that the material of the weld is not exposed to corrosion attacks.

In a further preferred way, the material of the top layer may also be chosen such that it behaves anodically with respect to the material of the workpiece, and also consequently acts as a sacrificial anode with respect to the latter. With such a choice of the material of the top layer, it is possible in particular to restore the properties that existed before the formation of the weld, as long as the workpiece is provided with a coating formed as a sacrificial anode.

In particular, the materials may be chosen in such a way that the material of the workpieces comprises an aluminum alloy and the top layer consists of aluminum, the workpieces in a further preferred way also having a coating of aluminum.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

The invention is described below on the basis of a drawing, which merely represents a preferred exemplary embodiment and in which:

FIG. 1 schematically shows the construction of a device for carrying out the method according to the invention.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

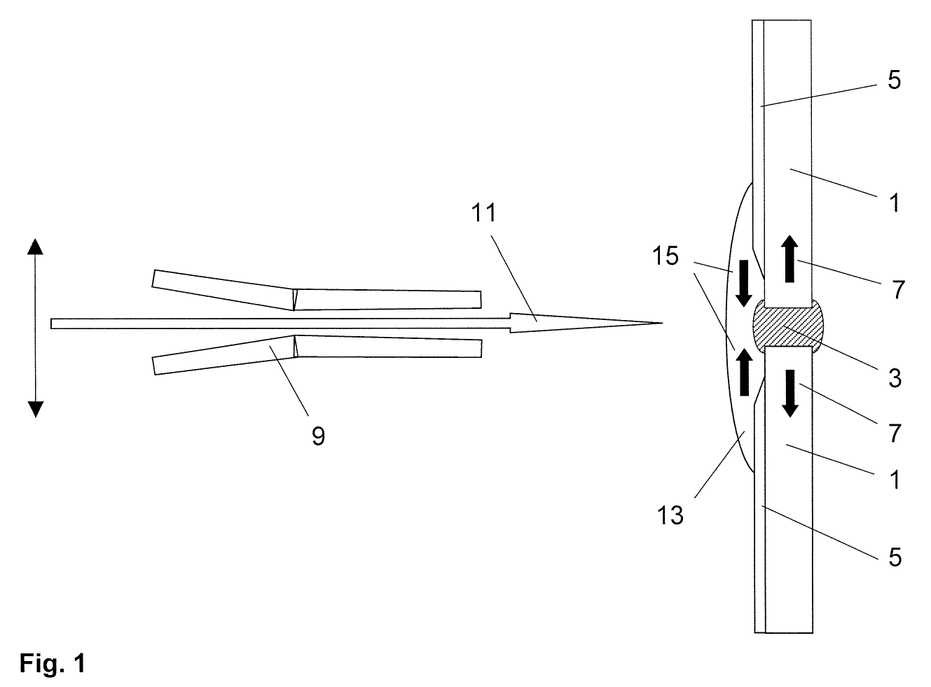

In FIG. 1, a workpiece 1 with a weld 3 is shown, it being possible for the weld 3 to be formed by known welding methods, for example gas fusion welding, arc welding and laser welding. The material of the workpiece 1 in the preferred exemplary employment described here is an aluminum alloy; a coating 5 of pure aluminum is also present on the workpiece 1, serving as a sacrificial anode and interrupted in the region of the weld 3 on account of the welding process. In the example described here, the thickness of the workpiece 1 may lie between 0.5 and 10 mm, and the coating 5 may be formed by multiple layers. In the case of the method according to the invention, however, it is also conceivable to use workpieces made of copper or titanium and also titanium or copper alloys. However, it is also possible to use workpieces made of steel; in particular whenever galvanized steel workpieces are subjected to subsequent treatment, it is possible to restore the originally good corrosion properties in the region of the weld.

On account of the welding process, the material of the weld 3 is formed from the material of the workpiece 1 itself and that of the coating 5, and consequently becomes more electronegative than the material of the workpiece. As a result, the weld 3 is initially more susceptible to corrosion than the rest of the workpiece 1. Furthermore, the weld 3 and the region of the workpiece 1 adjacent to it are under tensile stresses before the coating, so that, as explained at the beginning, the strength and the corrosion resistance are reduced here (see arrows 7).

To carry out the method according to the invention, the workpiece 1 is arranged at a distance of between 10 and 60 mm in front of a cold-gas spray nozzle 9, which is only schematically represented here.

In the cold-gas spray nozzle 9, particles with a size of between 10 and 60 μm, and preferably between 20 and 45 μm, are accelerated typically to speeds above the speed of sound in a gas jet 11. The material of the particles in the present exemplary embodiment is aluminum, and nitrogen is used as the process gas, it being possible for the process gas to be preheated and the process gas being at a pressure of between 5 and 60 bar, with preference between 20 and 40 bar.

The particles in the gas jet 9 impinge on the workpiece 1 in the region of the weld 3 and form a top layer 13 over the weld 3. In this case, the gas jet 9 has a typical diameter of from 2 to 10 mm, so that, with preference, the region of the weld 3 is passed over repeatedly in lines, in order to apply the top layer 13 of pure aluminum to the region of the weld 3 with a thickness of from 0.05 to 10 mm.

Applying the top layer 13 to the weld 5 in the way according to the invention by means of cold-gas spraying has the effect that the particles bond together in the top layer 13 and to the workpiece 1 on account of the high kinetic energy of the particles and the resultant release of heat on impingement on the workpiece 1. Furthermore, at the beginning of the coating process, compressive stresses are introduced into the workpiece 1 itself, thereby compensating for tensile stresses 7 that are present after the welding. After that, compressive stresses (arrow 15) are built up in the top layer 13, due in part to the constant impact of further solid particles.

This gives rise to the possibility of using the application of a cold-gas-sprayed top layer 13 to the surface of a previously formed weld 3 to compensate for the tensile stresses 7 in it, and consequently increase the strength. In this way, the tendency for cracks to form is also greatly reduced, so that in this way the corrosion resistance of the weld 3 is improved.

Since the top layer 13 consists of pure aluminum in the preferred exemplary embodiment described here, the top layer 13 behaves anodically both with respect to the workpieces 1 and with respect to the weld 3, so that in this way the corrosion resistance of the welded workpiece is improved.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A method for the subsequent treatment of a weld on a workpiece, said method comprising the steps of:
providing the workpiece with the weld; and
applying a top layer to the surface of the weld by cold-gas spraying.

2. The method as claimed in claim 1,
said cold-gas sprayed top layer being formed of particles lying between 10 and 60 μm.

3. The method as claimed in claim 1,
said workpiece comprising aluminum or aluminum alloys.

4. The method as claimed in claim 1,
said workpiece comprising titanium or titanium alloys.

5. The method as claimed in claim 1,
said workpiece comprising steel.

6. The method as claimed in claim 5,
said workpiece being provided with a coating comprising zinc.

7. The method as claimed in claim 1,
said workpiece comprising copper or copper alloys.

8. The method as claimed in claim 1,
said top layer comprising material behaving anodically with respect to the material of the weld.

9. The method as claimed in claim 1,
said top layer comprising material behaving anodically with respect to the material of the workpiece.

10. The method as claimed in claim 8,
said workpiece comprising an aluminum alloy,
said top layer consisting of aluminum.

11. The method as claimed in claim 10,
said workpiece including a coating of aluminum.

12. The method as claimed in claim 2,
said particles lying between 20 and 45 μm.

13. The method as claimed in claim 8,
said top layer comprising material behaving anodically with respect to the material of the workpiece.

14. The method as claimed in claim 9,
said workpiece comprising an aluminum alloy,
said top layer consisting of aluminum.

15. The method as claimed in claim 3,
said top layer comprising material behaving anodically with respect to the material of the weld.

16. The method as claimed in claim 4,
said top layer comprising material behaving anodically with respect to the material of the weld.

17. The method as claimed in claim 3,
said top layer comprising material behaving anodically with respect to the material of the workpiece.

18. The method as claimed in claim 4,
said top layer comprising material behaving anodically with respect to the material of the workpiece.

19. The method as claimed in claim 15,
said top layer comprising material behaving anodically with respect to the material of the workpiece.

20. The method as claimed in claim 16,
said top layer comprising material behaving anodically with respect to the material of the workpiece.
